(19) United States
(12) Patent Application Publication
(10) Pub. No.: US 2012/0036579 A1
(43) Pub. Date: Feb. 9, 2012

(54) SYSTEM AND METHOD FOR DETECTING ABNORMAL SIP TRAFFIC ON VOIP NETWORK

(76) Inventors: Chang-Yong LEE, Seoul (KR); Hwan-Kuk KIM, Seoul (KR); Kyoung-Hee KO, Incheon (KR); Jeong-Wook KIM, Seoul (KR); Hyun-Cheol JEONG, Seoul (KR)

(21) Appl. No.: 12/964,165

(22) Filed: Dec. 9, 2010

(30) Foreign Application Priority Data
Aug. 3, 2010 (KR) 10-2010-0074934

(51) Int. Cl. G06F 12/14

(52) U.S. Cl. 726/25

(57) ABSTRACT

Provided is a system for detecting abnormal traffic on a network. The system includes: a receiving module which receives session initiation protocol (SIP) traffic information from a network; a decoding module which receives the SIP traffic information from the receiving module and decodes the received SIP traffic information; a traffic information database (DB) which receives the decoded SIP traffic information from the decoding module and stores the received SIP traffic information; an analysis traffic information DB which collects information from the traffic information DB for a predetermined period and stores the collected information as analysis traffic information; a reference traffic information DB which stores reference traffic information; and an attack detection module which compares the analysis traffic information with the reference traffic information and detects whether analysis traffic is attack traffic.

### RELATED APPLICATION

This application claims priority from Korean Patent Application No. 10-2010-0074934 filed on Aug. 3, 2010, the disclosure of which is incorporated herein by reference in its entirety.

### BACKGROUND OF THE INVENTION

1. Field of the Invention

The present invention relates to a system and method for detecting abnormal traffic on a network.

2. Description of the Related Art

Conventional technologies related to a system for detecting abnormal traffic on a network analyze characteristics of Internet protocol (IP) traffic based only on 5-tuple information (i.e., source IP, source port, destination IP, destination port, and protocol (transmission control protocol (TCP), user datagram protocol (UDP), or Internet control message protocol (ICMP)) of the IP traffic and detect abnormal traffic based on the analysis result. However, in the case of session initiation protocol (SIP) application services which have explosively grown in popularity with the development of Internet telephony, conventional IP traffic monitoring technology and abnormal IP traffic detection technology are unable to effectively monitor SIP traffic or detect abnormal SIP traffic.

This is first because of universal resource identifiers (URIs) that are used to provide application services. That is, SIP traffic uses URIs in addition to the IP and port information, but the conventional technologies cannot properly monitor the URIs. Furthermore, although SIP traffic for call setup and real-time transport protocol (RTP) traffic for media transmission are actually in the same application service session, they may be delivered through different paths. However, conventional IP traffic monitoring equipment or IP-based security equipment cannot recognize that.

Accordingly, this has led to a demand for a system that can detect abnormal SIP traffic (e.g., distributed denial-of-service (DDoS) attack traffic, SCAN attack traffic, etc.) on a network.

### SUMMARY OF THE INVENTION

Aspects of the present invention provide an abnormal traffic detection system which can detect abnormal session initiation protocol (SIP) traffic on a network.

Aspects of the present invention also provide an abnormal traffic detection method used to detect abnormal SIP traffic on a network.

However, aspects of the present invention are not restricted to the one set forth herein. The above and other aspects of the present invention will become more apparent to one of ordinary skill in the art to which the present invention pertains by referencing the detailed description of the present invention given below.

According to an aspect of the present invention, there is provided an abnormal traffic detection system including: a receiving module which receives SIP traffic information from a network; a decoding module which receives the SIP traffic information from the receiving module and decodes the received SIP traffic information; a traffic information database (DB) which receives the decoded SIP traffic information from the decoding module and stores the received SIP traffic information; an analysis traffic information DB which collects information from the traffic information DB for a predetermined period and stores the collected information as analysis traffic information; a reference traffic information DB which stores reference traffic information; and an attack detection module which compares the analysis traffic information with the reference traffic information and detects whether analysis traffic is attack traffic.

According to another aspect of the present invention, there is provided an abnormal traffic detection method including: receiving SIP traffic information from a network; decoding the received SIP traffic information; collecting the decoded SIP traffic information for a predetermined period and generating analysis traffic information; comparing the analysis traffic information with reference traffic information and detecting whether analysis traffic is at least one of SIP distributed denial-of-service (DDoS) attack traffic, SIP SCAN attack traffic, and real-time transport protocol (RTP) DDoS attack traffic; and alerting a user when it is detected that the analysis traffic is at least one of the SIP DDoS attack traffic, the SIP SCAN attack traffic, and the RTP DDoS attack traffic.

### BRIEF DESCRIPTION OF THE DRAWINGS

The above and other aspects and features of the present invention will become more apparent by describing in detail exemplary embodiments thereof with reference to the attached drawings, in which:

FIG. 1 is a diagram illustrating the configuration of an abnormal traffic detection system according to an exemplary embodiment of the present invention;

FIG. 2 is a diagram illustrating an example of session initiation protocol (SIP) traffic information received by a receiving module of the abnormal traffic detection system according to the exemplary embodiment of the present invention;

FIG. 3 is a diagram illustrating a detection method used by an SIP distributed denial-of-service (DDoS) traffic detection module of the abnormal traffic detection system according to the exemplary embodiment of the present invention;

FIG. 4 is a diagram illustrating the effect of the abnormal traffic detection system according to the exemplary embodiment of the present invention;

FIG. 5 is a diagram illustrating an abnormal traffic detection system according to another exemplary embodiment of the present invention;

FIG. 6 is a flowchart illustrating an abnormal traffic detection method according to an exemplary embodiment of the present invention; and

FIG. 7 is a flowchart illustrating an abnormal traffic detection method according to another exemplary embodiment of the present invention.

### DETAILED DESCRIPTION OF THE INVENTION

Advantages and features of the present invention and methods of accomplishing the same may be understood more readily by reference to the following detailed description of exemplary embodiments and the accompanying drawings. The present invention may, however, be embodied in many different forms and should not be construed as being limited to the embodiments set forth herein. Rather, these embodiments are provided so that this disclosure will be thorough and complete and will fully convey the concept of the invention to those skilled in the art, and the present invention will only be defined by the appended claims. In the drawings, sizes and relative sizes of elements may be exaggerated for clarity.

Like reference numerals refer to like elements throughout the specification. As used herein, the term “and/or” includes any and all combinations of one or more of the associated listed items.

As used herein, the singular forms “a”, “an” and “the” are intended to include the plural forms as well, unless the context clearly indicates otherwise. It will be further understood that the terms “comprises” and/or “made of,” when used in this specification, specify the presence of stated components, steps, operations, and/or elements, but do not preclude the presence or addition of one or more other components, steps, operations, elements, and/or groups thereof.

It will be understood that, although the terms first, second, third, etc., may be used herein to describe various elements, these elements should not be limited by these terms. These terms are only used to distinguish one element from another element. Thus, a first element discussed below could be termed a second element without departing from the teachings of the present invention

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

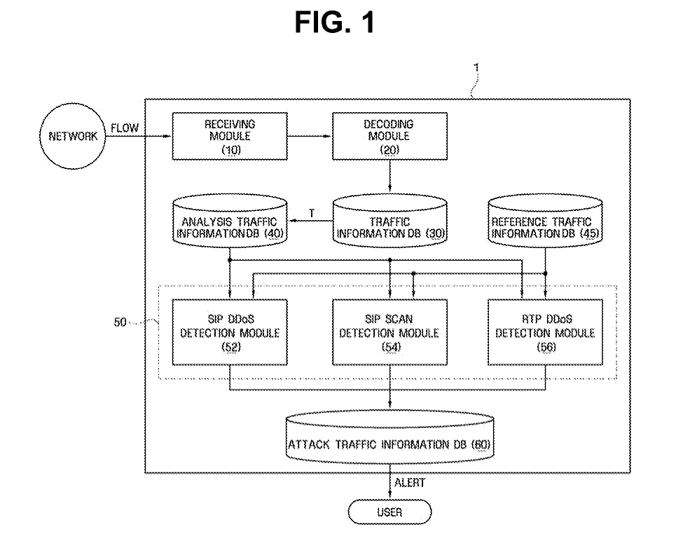

Hereinafter, an abnormal traffic detection system according to an exemplary embodiment of the present invention will be described with reference to FIGS. 1 through 4.

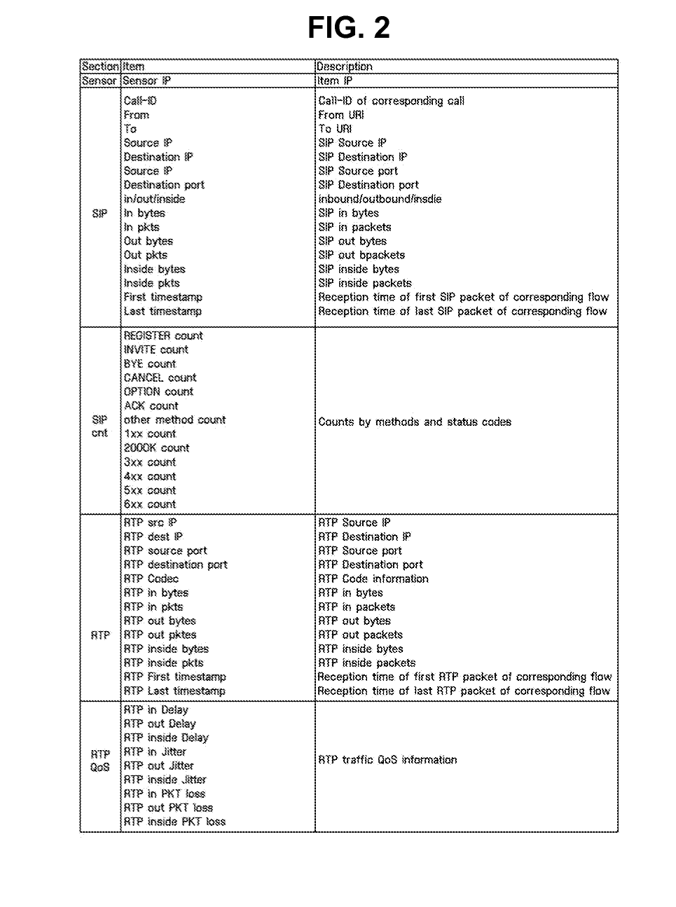

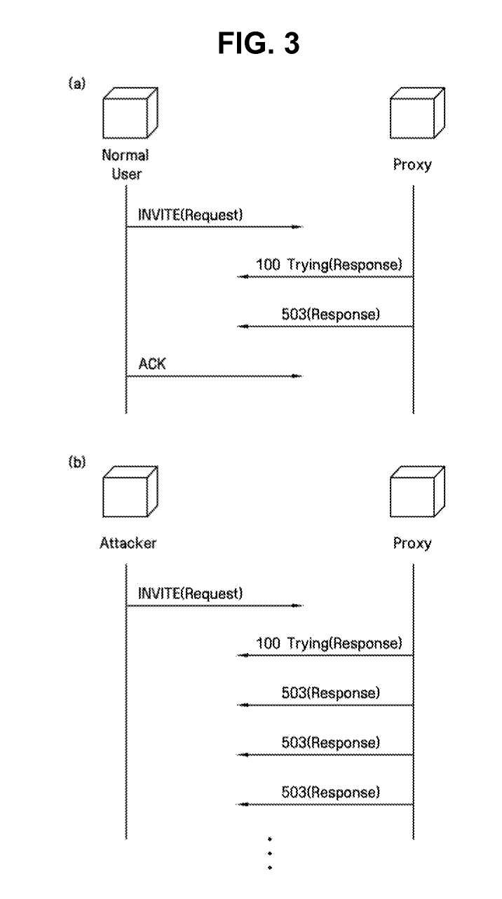

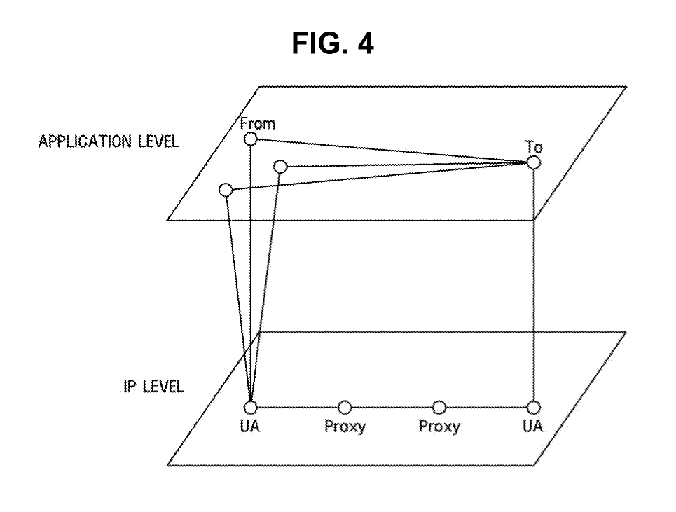

FIG. 1 is a diagram illustrating the configuration of an abnormal traffic detection system 1 according to an exemplary embodiment of the present invention. FIG. 2 is a diagram illustrating an example of session initiation protocol (SIP) traffic information received by a receiving module 10 of the abnormal traffic detection system 1 according to the exemplary embodiment of the present invention. FIG. 3 is a diagram illustrating a detection method used by an SIP distributed denial-of-service (DDoS) detection module 52 of the abnormal traffic detection system 1 according to the exemplary embodiment of the present invention. FIG. 4 is a diagram illustrating the effect of the abnormal traffic detection system 1 according to the exemplary embodiment of the present invention.

Referring to FIG. 1, the abnormal traffic detection system 1 according to the current exemplary embodiment may include the receiving module 10, a decoding module 20, a traffic information database (DB) 30, an analysis traffic information DB 40, a reference traffic information DB 45, and an attack detection module 50.

The receiving module 10 may receive SIP traffic information from a network. Specifically, the receiving module 10 may receive the SIP traffic information from the network by using a plurality of collection sensors (not shown). Here, the SIP traffic information may be a NetFlow-based SIP traffic flow. Specifically, the SIP traffic information may be an SIP traffic flow that follows, e.g., a NetFlow V9 format. The SIP traffic information may include information about SIP traffic and information about real-time transport protocol (RTP), as illustrated in FIG. 2.

The decoding module 20 may receive the SIP traffic information from the receiving module 10 and decode the received SIP traffic information. Here, the term “decode” denotes classifying the received SIP traffic (e.g., an SIP traffic flow that follows the NetFlow V9 (Version 9) format) according to item, thereby converting the SIP traffic information into a data structure. The received SIP traffic may be stored, in the form of the data structure, in the traffic information DB 30.

The traffic information DB 30 may be a storage unit that receives the decoded SIP traffic information from the decoding module 20 and stores the received SIP traffic information. The traffic information DB 30 may generate an information storage table at intervals of, e.g., one hour and store the decoded SIP traffic information in the generated information storage table.

The analysis traffic information DB 40 may be a storage unit that collects information from the traffic information DB 30 for a predetermined period T and stores the collected information as analysis traffic information which is used to detect whether SIP traffic is abnormal traffic (e.g., attack traffic). Here, the predetermined period T may be, e.g., one minute.

The reference traffic information DB 45 may be a storage unit that stores reference traffic information. The reference traffic information will be described in more detail when the attack detection module 50 is described.

The attack detection module 50 may compare the analysis traffic information of the analysis traffic information DB 40 with the reference traffic information of the reference traffic information DB 45 and detect whether analysis traffic is abnormal traffic (e.g., attack traffic). Specifically, referring to FIG. 1, the attack detection module 50 may include the SIP DDoS detection module 52, an SIP SCAN detection module 54, and an RTP DDoS detection module 56.

The SIP DDoS detection module 52 may detect whether the analysis traffic is SIP DDoS attack traffic. Specifically, the SIP DDoS detection module 52 may detect the analysis traffic as potential SIP DDoS attack traffic when at least one of the SIP traffic volume, method ratio, and universal resource identifier (URI) ratio of the analysis traffic is greater than a corresponding threshold value of reference traffic.

More specifically, the SIP DDoS detection module 52 may detect the analysis traffic as the potential SIP DDoS attack traffic as follows. First, the SIP DDoS detection module 52 analyzes the SIP traffic volume, method ratio, and URI ratio information of the analysis traffic. The SIP traffic volume, method ratio and URI ratio information of the analysis traffic may be as shown in Table 1 below (see also FIG. 2).

TABLE 1

| Item | | Description |
|---|---|---|
| SIP traffic | SIP bps | Amount of SIP traffic |
| volume | SIP/RTP ratio | Amount of SIP traffic/amount of RTP |
| (in bytes) | | traffic |
| Method | INVITE ratio | INVITE method count/total method count |
| ratio | REGISTER ratio | REGISTER method count/total method |
| | | count |
| | 100/200 ratio | 100 method count/200 method count |
| URI ratio | From/To ratio | From count/To count |

Then, the SIP DDoS detection module 52 compares the SIP traffic volume, method ratio and URI ratio information of the analysis traffic with corresponding threshold values of the reference traffic which are stored in the reference traffic information DB 45. When at least one of the SIP traffic volume, method ratio and URI ratio of the analysis traffic is greater than a corresponding threshold value of the reference traffic, the SIP DDoS detection module 52 detects the analysis traffic as the potential SIP DDoS attack traffic. The threshold value of the reference traffic for each item may be as shown in Table 2 below.

TABLE 2

| Item | | Threshold Value |
|---|---|---|
| SIP traffic | SIP bps | Average amount of SIP traffic per day of |
| volume | | the week and per time slot for three |
| (in bytes) | | weeks + a |
| | SIP/RTP ratio | Average amount of SIP traffic/average |
| | | amount of RTP traffic per day of the week |
| | | and per time slot for three weeks + a |
| Method | INVITE ratio | Average INVITE method count/average |
| ratio | | total method count for one week + a |
| | REGISTER ratio | Average REGISTER method count/ |
| | | average total method count for one |
| | | week + a |
| | 100/200 ratio | Average 100 method count/average 200 |
| | | method count for one week + a |
| URI ratio | From/To ratio | From count/To count per day of the week |
| | | and per time slot for one week + a |

For example, when the ‘amount (bytes) of SIP traffic on current day of the week, at current time’ of analysis traffic is greater than the ‘average amount (bytes) of SIP traffic for three weeks on same day of the week, at same time+a’ of reference traffic, the SIP DDoS detection module 52 detects the analysis traffic as the potential SIP DDoS attack traffic. Here, ‘a’ is an offset value and can be arbitrarily adjusted by a user as desired.

Even when the ‘SIP bps’ of the analysis traffic is less than a corresponding threshold value of the reference traffic, if the ‘INVITE ratio’ of the analysis traffic is greater than a corresponding threshold value of the reference traffic, the analysis traffic is detected as the potential SIP DDoS attack traffic. That is, the SIP DDoS detection module 52 detects the analysis traffic as the potential SIP DDoS attack traffic when at least one of the SIP traffic volume, method ratio and URI ratio of the analysis traffic is greater than a corresponding threshold value of the reference traffic.

Once detecting the analysis traffic as the potential SIP DDoS attack traffic, the SIP DDoS detection module 52 analyzes an acknowledgement (ACK) method count of the analysis traffic and a ratio of a response method to a request method of the analysis traffic. This is because if the analysis traffic is the SIP DDoS attack traffic, the ACK method may not exist in the analysis traffic as illustrated in (b) of FIG. 3 (unlike in normal traffic illustrated in (a) of FIG. 3), or the ratio of the response method to the request method may be excessively high (e.g., response method count/request method count ≧4). Therefore, the SIP DDoS detection module 52 may detect the analysis traffic as the SIP DDoS attack traffic when the ACK method count of the analysis traffic is zero or when the ratio of the response method to the request method is four or greater.

The SIP SCAN detection module 54 also may be a module that detects the analysis traffic as SIP SCAN attack traffic when at least one of the SIP traffic volume, method ratio and URI ratio of the analysis traffic is greater than a corresponding threshold value of the reference traffic. Specifically, the SIP SCAN detection module 54 may detect the analysis traffic as the SIP SCAN attack traffic when at least one of the SIP traffic volume, method ratio and URI ratio of the analysis traffic is greater than a corresponding threshold value of the reference traffic.

More specifically, the SIP SCAN detection module 54 may detect the analysis traffic as the SIP SCAN attack traffic as follows. First, the SIP SCAN detection module 54 analyzes the SIP traffic volume, method ratio, and URI ratio information of the analysis traffic. The SIP traffic volume, method ratio and URI ratio information of the analysis traffic may be as shown in Table 3 below (see also FIG. 2)

TABLE 3

| Item | | Description |
|---|---|---|
| SIP traffic volume | SIP bps | Amount of SIP traffic |
| (in bytes) | | |
| Method ratio | INVITE ratio | INVITE method count/total |
| | | method count |
| | INVITE/200 OK | INVITE method count/200 OK |
| | ratio | count |
| URI ratio | From/To ratio | From count/To count |

Then, the SIP SCAN detection module 54 compares the SIP traffic volume, method ratio and URI ratio information of the analysis traffic with corresponding threshold values of the reference traffic which are stored in the reference traffic information DB 45. When at least one of the SIP traffic volume, method ratio and URI ratio of the analysis traffic is greater than a corresponding threshold value of the reference traffic, the SIP SCAN detection module 54 detects the analysis traffic as the SIP SCAN attack traffic. The threshold value of the reference traffic for each item may be as shown in Table 4 below.

TABLE 4

| Item | | Threshold value |
|---|---|---|
| SIP traffic | SIP bps | Average amount of SIP traffic per day of |
| volume | | the week and per time slot for three |
| (in bytes) | | weeks + a |
| Method | INVITE ratio | Average INVITE method count/average |
| ratio | | total method count for one week + a |
| | INVITE/200 OK | Average INVITE method count/average |
| | ratio | 200 OK count for one week + a |
| URI ratio | From/To ratio | From count/To count per day of the week |
| | | and per time slot for one week + a |

The process in which the SIP SCAN detection module 54 detects the analysis traffic as the SIP SCAN attack traffic is similar to the above-described detection process of the SIP DDoS detection module 52, and thus a redundant description thereof is omitted.

Lastly, the RTP DDoS detection module 56 may detect the analysis traffic as RTP DDoS attack traffic in a similar process. The RTP DDoS detection module 56 may detect the analysis traffic as the RTP DDoS attack traffic when at least one of the RTP traffic volume and RTP traffic mean opinion score (MOS) of the analysis traffic is greater than a corresponding threshold value of the reference traffic which is stored in the reference traffic information DB 45. Here, analysis items and threshold values may be as shown in Tables 5 and 6.

TABLE 5

| | |
|---|---|
| Item | Description |

| | | |
|---|---|---|
| RTP traffic volume | RTP bps | Amount of RTP traffic |
| (in bytes) | | |
| QoS information | MOS | Average MOS of RTP traffic |

TABLE 6

| Item | | Threshold value |
|---|---|---|
| RTP traffic | RTP bps | Average amount of RTP traffic per day of |
| volume | | the week and per time slot for three weeks + a |
| (in bytes) | | |
| QoS | MOS | Average MOS of RTP traffic for one week + a |
| information | | |

Referring back to FIG. 1, when at least one of the SIP DDoS detection module 52, the SIP SCAN detection module 54, and the RTP DDoS detection module 56 detects the analysis traffic as the DDoS or SCAN attack traffic, information about this attack traffic is stored in the attack traffic information DB 60. Then, a user may be alerted to the presence of the attack traffic on the network.

The abnormal traffic detection system 1 according to the current exemplary embodiment can detect abnormal SIP traffic on the network (e.g., a voice over Internet protocol (VoIP) network). Specifically, referring to FIG. 4, a conventional abnormal traffic detection system detects abnormal traffic based only on 5-tuple information. Thus, even when traffic flowing from one source to one destination at an Internet protocol (IP) level attacks one target (one To) using a number of different URIs (a number of different Froms) at an application level, the conventional abnormal traffic detection system fails to detect this as a DDoS attack.

However, the abnormal traffic detection system 1 according to the current exemplary embodiment detects DDoS attack traffic at the application level based on various information, as described above. Thus, SIP DDoS attack traffic as the one illustrated in FIG. 4 can be detected.

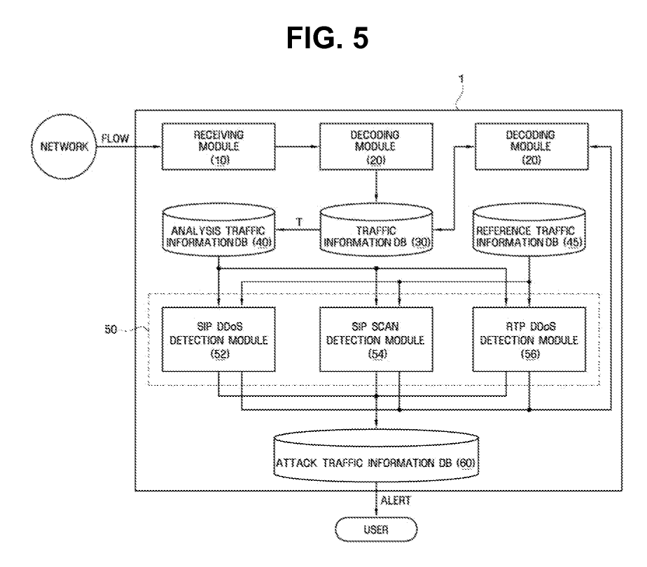

Hereinafter, an abnormal traffic detection system according to another exemplary embodiment of the present invention will be described with reference to FIG. 5.

FIG. 5 is a diagram illustrating an abnormal traffic detection system 1 according to another exemplary embodiment of the present invention.

For the sake of simplicity, a redundant description of elements and features identical to those of the previous exemplary embodiment will be omitted. That is, the following description will focus on differences from the previous exemplary embodiment.

Referring to FIG. 5, the abnormal traffic detection system 1 according to the current exemplary embodiment may further include a reference traffic information generation module 70.

When an attack detection module 50 detects analysis traffic as non-attack traffic, the reference traffic information generation module 70 may update reference traffic information stored in a reference traffic information DB 45 to SIP traffic information stored in a traffic information DB 30. That is, the reference traffic information generation module 70 may update the reference traffic information stored in the reference traffic information DB 45 to the normal traffic information, thereby updating a threshold value for each analysis item.

When the reference traffic information generation module 70 is further installed, each threshold value of the reference traffic can be adjusted in real time according network conditions. This enables more reliable detection of attack traffic.

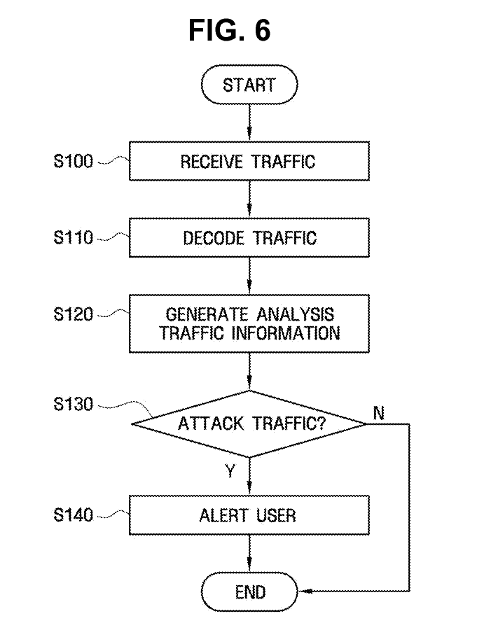

Hereinafter, an abnormal traffic detection method according to an exemplary embodiment of the present invention will be described with reference to FIG. 6.

FIG. 6 is a flowchart illustrating an abnormal traffic detection method according to an exemplary embodiment of the present invention.

Referring to FIG. 6, SIP traffic information is received from a network (operation S100), and the received SIP traffic information is decoded (operation S110).

Here, the network may include a VoIP network, and the SIP traffic information received from the network may include NetFlow-based SIP traffic flow information.

Next, the decoded SIP traffic information is collected for a predetermined period to generate analysis traffic information (operation S120). As described above, the predetermined period may be, e.g., one minute.

Next, the analysis traffic information is compared with reference traffic information to detect whether analysis traffic is at least one of SIP DDoS attack traffic, SIP SCAN attack traffic, and RTP DDoS attack traffic (operation S130). When it is detected that the analysis traffic is attack traffic, a user is alerted (operation S140).

The process of detecting whether the analysis traffic is at least one of the SIP DDoS attack traffic, the SIP SCAN attack traffic, and the RTP DDoS attack traffic has been described above when describing the abnormal traffic detection system 1 of FIG. 1, and thus a redundant description thereof is omitted.

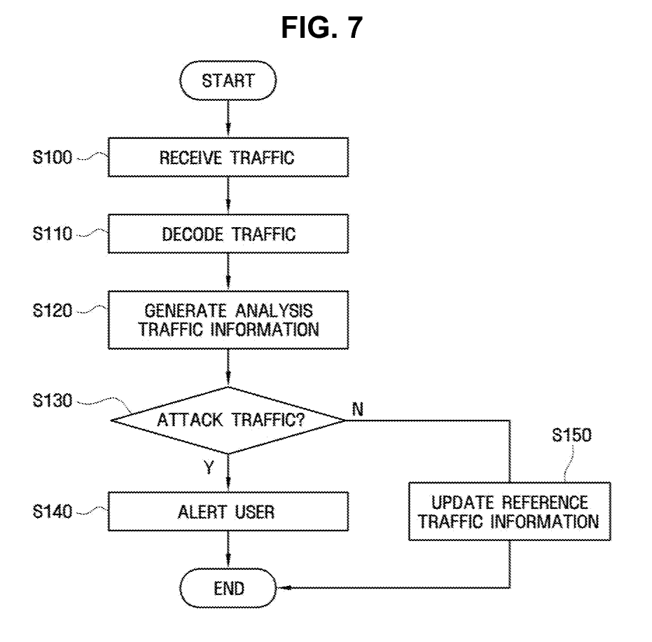

Hereinafter, an abnormal traffic detection method according to another exemplary embodiment of the present invention will be described with reference to FIG. 7.

FIG. 7 is a flowchart illustrating an abnormal traffic detection method according to another exemplary embodiment of the present invention.

Referring to FIG. 7, the abnormal traffic detection method according to the current exemplary embodiment further includes updating reference traffic information to analysis traffic information when it is detected in operation 5130 that analysis traffic is normal (non-attack) traffic (operation S150). Other features of the abnormal traffic detection method according to the current exemplary embodiment are the same as those of the abnormal traffic detection method according to the previous exemplary embodiment, and thus a redundant description thereof is omitted.

As described above, an abnormal traffic detection system according to exemplary embodiments of the present invention detects abnormal traffic (e.g., SIP DDoS attack traffic, SIP SCAN attack traffic, RTP DDoS attack traffic, etc.) on a network based on NetFlow-based SIP traffic flow information which includes various application layer information as well as 5-tuple information. Therefore, the abnormal traffic detection system can detect abnormal traffic more accurately than conventional detection systems.

While the present invention has been particularly shown and described with reference to exemplary embodiments thereof, it will be understood by those of ordinary skill in the art that various changes in form and detail may be made therein without departing from the spirit and scope of the present invention as defined by the following claims. The exemplary embodiments should be considered in a descriptive sense only and not for purposes of limitation.

What is claimed is:

1. An abnormal traffic detection system comprising:
a receiving module which receives Session Initiation Protocol (SIP) traffic information from a network;
a decoding module which receives the SIP traffic information from the receiving module and decodes the received SIP traffic information;
a traffic information database (DB) which receives the decoded SIP traffic information from the decoding module and stores the received SIP traffic information;
an analysis traffic information DB which collects information from the traffic information DB for a predetermined period and stores the collected information as analysis traffic information;
a reference traffic information DB which stores reference traffic information; and
an attack detection module which compares the analysis traffic information with the reference traffic information and detects whether analysis traffic is attack traffic.

2. The system of claim 1, wherein the network comprises a Voice over Internet Protocol (VoIP) network, and the SIP traffic information received by the receiving module comprises NetFlow-based SIP traffic flow information.

3. The system of claim 1, wherein the predetermined period comprises one minute.

4. The system of claim 1, wherein the attack detection module comprises an SIP Distributed Denial-of-Service (DDoS) detection module which detects whether the analysis traffic is SIP DDoS attack traffic, an SIP SCAN detection module which detects whether the analysis traffic is SIP SCAN attack traffic, and a Real-time Transport Protocol (RTP) DDoS detection module which detects whether the analysis traffic is RTP DDoS attack traffic.

5. The system of claim 4, wherein the SIP DDoS detection module detects the analysis traffic as potential SIP DDoS attack traffic when at least one of SIP traffic volume, method ratio and universal resource identifier (URI) ratio of the analysis traffic is greater than a corresponding threshold value of reference traffic and detects the analysis traffic as the SIP DDoS attack traffic when no acknowledgement (ACK) method exists in the analysis traffic detected as the potential SIP DDoS attack traffic or when a ratio of a response method to a request method is four or greater.

6. The system of claim 4, wherein the SIP SCAN detection module detects the analysis traffic as the SIP SCAN attack traffic when at least one of the SIP traffic volume, method ratio and URI ratio of the analysis traffic is greater than the corresponding threshold of the reference traffic.

7. The system of claim 4, wherein the RTP DDoS detection module detects the analysis traffic as the RTP DDoS attack traffic when at least one of RTP traffic volume and RTP traffic mean opinion score (MOS) of the analysis traffic is greater than a corresponding threshold value of the reference traffic.

8. The system of claim 1, further comprising a reference traffic information generation module which updates the reference traffic information stored in the reference traffic information DB to the SIP traffic information stored in the traffic information DB when the attack detection module detects the analysis traffic as non-attack traffic.

9. An abnormal traffic detection method comprising:
receiving SIP traffic information from a network;
decoding the received SIP traffic information;
collecting the decoded SIP traffic information for a predetermined period and generating analysis traffic information;
comparing the analysis traffic information with reference traffic information and detecting whether analysis traffic is at least one of SIP DDoS attack traffic, SIP SCAN attack traffic, and RTP DDoS attack traffic; and
alerting a user when it is detected that the analysis traffic is at least one of the SIP DDoS attack traffic, the SIP SCAN attack traffic, and the RTP DDoS attack traffic.

10. The method of claim 9, wherein the network comprises a VoIP network, and the SIP traffic information received from the network comprises NetFlow-based SIP traffic flow information.

11. The method of claim 9, wherein the predetermined period comprises one minute.

12. The method of claim 9, wherein the detecting of whether the analysis traffic is the SIP DDoS attack traffic comprises detecting the analysis traffic as potential SIP DDoS attack traffic when at least one of SIP traffic volume, method ratio and URI ratio of the analysis traffic is greater than a corresponding threshold value of reference traffic and detecting the analysis traffic as the SIP DDoS attack traffic when no ACK method exists in the analysis traffic detected as the potential SIP DDoS attack traffic or when a ratio of a response method to a request method is 4:1 or greater.

13. The method of claim 9, wherein the detecting of whether the analysis traffic is the SIP SCAN attack traffic comprises detecting the analysis traffic as the SIP SCAN attack traffic when at least one of the SIP traffic volume, method ratio and URI ratio of the analysis traffic is greater than the corresponding threshold of the reference traffic.

14. The method of claim 9, wherein the detecting of whether the analysis traffic is the RTP DDoS attack traffic comprises detecting the analysis traffic as the RTP DDoS attack traffic when at least one of RTP traffic volume and RTP traffic MOS of the analysis traffic is greater than a corresponding threshold value of the reference traffic.

15. The method of claim 9, further comprising updating the reference traffic information to the SIP traffic information when it is detected that the analysis traffic is non-attack traffic.
